(19) United States
(12) Patent Application Publication
(10) Pub. No.: US 2006/0002660 A1
(43) Pub. Date: Jan. 5, 2006

(54) Two-piece nose assembly with solid sleeve for optical subassembly

(76) Inventors: Martin Wisecarver, Los Banos, CA (US); Axel Mehnert, Sunnyvale, CA (US)

Correspondence Address: WORKMAN NYDEGGER;(F/K/A WORKMAN NYDEGGER & SEELEY), 60 EAST SOUTH TEMPLE, 1000 EAGLE GATE TOWER, SALT LAKE CITY, UT, 84111, US

(21) Appl. No.: 11/076,835

(22) Filed: Mar. 10, 2005

Related U.S. Application Data
(60) Provisional application No. 60/564,387, filed on Apr. 22, 2004.

(51) Int. Cl. G02B 6/36

(52) U.S. Cl. 385/53

(57) ABSTRACT

A two piece nose assembly for optoelectronic devices is disclosed. The assembly includes a first piece having a central bore and an annular alignment recess about the central bore. The first piece can be attached to a housing of the optical device. The assembly also includes an annular second piece designed to receive an optical connector and having an outside surface designed to interference fit with an inside surface of the annular alignment recess. The annular second piece has an inside surface having a hardness of at least 35 on the Rockwell “C” scale. The first piece has an annular groove on an outside surface thereof that defines a lip adjacent to the housing. The annular groove has a tapered edge that facilitates an optimized angle of incidence for a laser beam used to weld the first piece to the housing.

### CROSS-REFERENCE TO RELATED APPLICATIONS

This application claims priority to and the benefit of U.S. Provisional Patent Application Ser. No. 60/564,387, filed on Apr. 22, 2004, and entitled “Two Piece Nose Assembly With Solid Sleeve for Optical Subassembly”, which is incorporated herein by reference in its entirety.

### BACKGROUND OF THE INVENTION

1. The Field of the Invention

The present invention generally relates to the field of fiber optic couplers and, more specifically, to an at least two-piece nose assembly with a solid sleeve for joining to a ferrule containing an optical component or sub-assembly.

2. The Relevant Technology

Fiber optic technologies are increasingly used for transmitting voice and data signals. As a transmission medium, fiber optics provides a number of advantages over traditional electrical communication techniques. For example, light signals allow for extremely high transmission rates and very high bandwidth capabilities. Light signals also can be transmitted over greater distances without the signal loss typically associated with electrical signals on copper wire. These light signals are transmitted over optical waveguides, such as the optical fibers found in fiber optic cable.

To correct two adjacent optical waveguides or correct an optical waveguide with optical devices, such as, Ferrule-type plug/receptacle optical connectors are typically used to position two optical waveguides, such as optical fibers, so that light can propagate between the two waveguides. Alternatively, ferrule-type plug/receptacle optical connectors can be used between an optical waveguide and an optical component or subassembly. The ferrule-type connector is inserted into a sleeve that fixes the position of the optical fiber with respect to a laser, a photodiode, another optical fiber, or some other optical component. The sleeve is often inserted into a base that is fixed to a housing holding an optical component, such as, by way of example and not limitation, a transmitter optical sub-assembly (TOSA), a receiver optical sub-assembly (ROSA), a laser, a photodiode, or other optical components. The sleeve/base combination is sometimes referred to as a nose assembly. The ferrules and sleeves are manufactured to specific tolerances to ensure a proper friction fit between them, which allows the ferrule to be repeatedly removed and reconnected to the sleeve, while assuring proper alignment of the optical components.

There are a number of problems associated with the various connections between these components. One problem is that the material of the sleeve is typically a ceramic, plastic, or soft metal. As the ferrule is repeatedly inserted and removed from the sleeve during positioning of an optical fiber or component, portions of the sleeve material can adhere to the outside surface of the ferrule. Over time, this can cause a buildup of material on the outside surface of the ferrule, causing the ferrule to stick in the housing. This condition is sometimes known as “cold welding”. This can make it very difficult to insert and remove the ferrule. In extreme cases, parts that are “cold welded” together must be physically broken to separate the components. Additionally, the material particles would sometimes contaminate the optical components, thus degrading the optical signal. In some cases, the above mentioned problems have resulted in manufacturing losses of 30% or more (i.e. 30% of parts produced did not meet required tolerances).

Another problem associated with the interconnections of these components is the connection of the base to the housing. The base and housing are oftentimes both made of metal. The base has a hole in its center that allows for a light signal to pass from the fiber optic cable in the ferrule to/from the optical component within the housing. In previous configurations, the base has a smooth outside surface that is perpendicular to the surface of the housing. An alignment process ensures that the hole in the base provides an optical alignment between the optical fiber and the optical component. Once the base and housing are properly aligned, the base is welded to the housing using, for example, a laser welding apparatus.

There are several problems associated with this welding procedure. First, the laser does not always strike precisely at the junction between the base and the housing. Since the parts themselves act as heat sinks, this results in additional laser energy being used to sufficiently melt the housing and base to form the weld. This additional energy causes the components to become very hot and therefore take a long time to cool. During the cool down period, a lateral displacement of the base with respect to the housing can occur, known as post weld shift. The post weld shift can be sufficient to cause the optical components to be misaligned, thereby degrading the optical signal. This problem can be both expensive and time consuming to correct.

Additionally, if the laser is slightly misaligned, the beam melts only a portion of the base or a portion of the housing. The rest of the heat can dissipate into either the housing or the base. This results in no weld being formed, which can potentially cause the pieces to separate entirely. Such a break can result in an interruption of data signals, or even complete data loss.

### BRIEF SUMMARY OF THE EMBODIMENTS

To overcome these and other problems, embodiments of the present invention provide a two piece nose assembly for optoelectronic devices. The assembly includes a first piece having a central bore and an annular alignment recess about the central bore. The first piece can be attached to a housing of the optoelectronic device. The assembly also includes an annular sleeve designed to receive an optical connector and having an outside surface designed to interference fit with an inside surface of the annular alignment recess in the first piece. The annular second piece has an inside surface having a hardness of at least 35 on the Rockwell “C” scale.

In exemplary embodiments, the first piece can have an annular groove on an outside surface thereof that defines a lip adjacent to the housing. The annular groove can have a tapered edge that facilitates an optimized angle of incidence for a laser beam used to weld the first piece to the housing. This design provides several advantages. First, the lip that receives the laser beam helps to reduce the heat loss to the greater mass of the whole metal body of the base. This allows fast pulse heating of the lip and metal housing of the optoelectronic device to the melting temperature, and a slow enough cooling phase change to a solid so as to not crystallize the weld nugget grain structure. This results in a weld that is both more uniform and stronger than previous designs.

Additionally, the area sacrificed from the edge on the base to form the weld puddle is more or less the same thickness laterally with respect to the weld angle of incidence. Thus, a radial shift towards the center of the part or away from it in the originally fixed laser weld beam alignment is less sensitive compared to the 90 degree cylinder edge of previous designs. This reduces or even eliminates the problem of post weld shift discussed above.

The hardening process for the inside surface of the annular sleeve alleviates the problem of ablation of the ferrule/sleeve that results in the cold welding problem discussed above. Ferrules can be inserted and removed as often as desired without significantly increasing the difficulty of inserting and removing the ferrule.

These and other objects and features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1A illustrates a side view of one exemplary embodiment of a two-piece nose assembly with a solid sleeve according to the present invention;

FIG. 1B illustrates a cross-sectional side view of the two piece nose assembly of FIG. 1A along the lines B-B;

FIG. 1C illustrates a perspective view of the two piece nose assembly of FIGS. 1A and 1B with the pieces joined together;

FIG. 1D illustrates a perspective view of the two piece nose assembly of FIGS. 1A-1C with the pieces separated;

FIG. 1E illustrates a close-up view of a portion of FIG. 1D showing the base and housing;

FIG. 2A illustrates a side view of an alternate exemplary embodiment of a two-piece nose assembly with a solid sleeve according to the present invention;

FIG. 2B illustrates a cross-sectional side view of the two piece nose assembly of FIG. 2A along the lines B-B;

FIG. 2C illustrates a perspective view of the two piece nose assembly of FIGS. 2A and 2B with the pieces joined together;

FIG. 2D illustrates a perspective view of the two piece nose assembly of FIGS. 2A-2C with the pieces separated; and

FIG. 2E illustrates a close-up view of a portion of FIG. 2D showing the base and housing.

### DETAILED DESCRIPTION OF THE EMBODIMENTS

Embodiments of the present invention provide several solutions to the problems identified in the prior art. Specifically, embodiments of the present invention disclose a sleeve that receives a ferrule. The sleeve is constructed from a material that resists the ablation associated with previous sleeves. Additionally, a base is disclosed that is constructed in such a way as to minimize the amount of post weld shift that occurs when the base is attached to a housing.

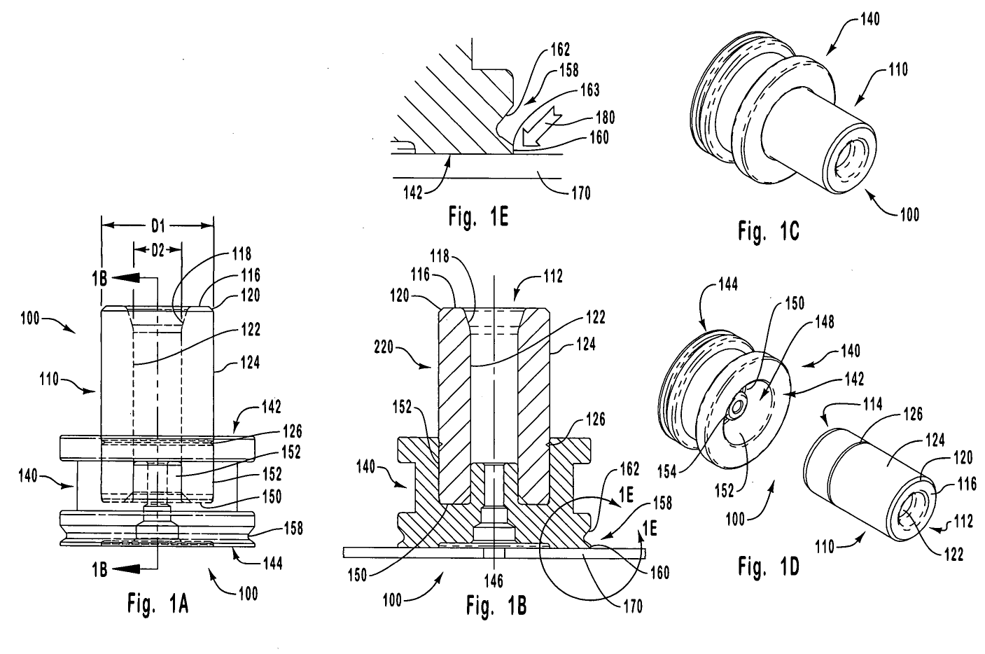

FIGS. 1A-1E illustrate different views of one exemplary embodiment of a two-piece nose assembly, designated generally as reference numeral 100. In this exemplary embodiment, nose assembly 100 is designed to cooperate with a Lucent Connector (LC connector, not shown). However, those skilled in the art will realize that exemplary embodiments of the present invention can be constructed to work with almost any standard connector. Such connectors can include, by way of example and not limitation, ST, STII, FC, AFC, FDDI, ESCON, and SMA, or any other connector designed to receive a ferrule.

With reference to FIG. 1A, in this exemplary embodiment, nose assembly 100 includes a sleeve 110 and a base 140. This two piece construction makes machining and manufacturing the parts easier and more cost efficient. However, exemplary embodiments of the present invention can also be used with nose assemblies that have more than two parts. Such nose assemblies are also contemplated to fall within the scope of the exemplary embodiments. The invention is therefore not limited to the two piece construction shown in FIGS. 1A-1E.

Turning to FIGS. 1B and 1C, in this exemplary embodiment, sleeve 110 is an annular member sized and configured to i) be interference fit into base 140 and ii) receive a ferrule (not shown) containing an optical fiber (not shown). Sleeve 110 includes a first end 112 and a second end 114. First end 112 can have a top surface 116, an inside beveled edge 118, and an outside beveled edge 120. Beveled edge 118 makes it easier to insert a ferrule (not shown) into sleeve 110, while beveled edge 120 can aid with placement of sleeve 110 relative to an optical component or other optical connector. It will be understood that second end 114 can also include one or more beveled edges. Although reference is made to the use of various beveled edges 118 and 120, one will understand that the edges of sleeve 110 can have other configurations to aid with inserting a ferrule (not shown) into sleeve 110. For instance, at least a portion of each edge 118 and 120 can have a tapered or curved profile.

In this exemplary embodiment, as illustrated in FIG. 1C, sleeve 110 has an outside diameter D1, and an inside diameter D2. Outside diameter D1 is chosen to allow sleeve 110 to fit into base 140, such that an outside surface 124 can interference fit with a portion of base 140. Additionally, inside diameter D2 is chosen to allow an inside surface 122 to fit around a post member 154 that is internal to base 140, such that inside surface 122 can interference fit about this post member, as will be discussed in more detail hereinafter. The inside diameter D2 can be uniform for the entire length of sleeve 110.

Sleeve 110 can also include a notch 126 in outer surface 124. Notch 126 is located towards second end 114. When sleeve 110 is fully inserted into base 140, notch 126 is not visible, thus providing a visual indicator that sleeve 110 is fully inserted into base 140. This notch 126 can extend around the entire periphery of sleeve 110 or can be at least partially disposed around the periphery of sleeve 110. In other configurations, other visual indicators can be used to indicate when sleeve 110 is fully inserted into base 140. For instance, a series of holes or recesses can be substituted for notch 126. In still other configurations, visual markings can be applied to outer surface 124 without changing the generally planar configuration of outer surface 124 as occurs with formation of notch 126. Various other structures or techniques for providing a visual indicator of the desired position of sleeve 110 relative to base 140 can be used and are known to those skilled in the art.

In order to overcome the problems associated with cold welding discussed above, one exemplary embodiment provides that sleeve 110 be made from metal and that inside surface 122 be heat treated. Heat treating hardens inside surface 122 so that portions of inside surface 122 do not scrape off when a ferrule (not shown) is repeatedly inserted and removed. In an exemplary embodiment, inside surface 122 is heat treated until it has a hardness of at least 35 on the Rockwell “C” scale.

In exemplary embodiments, sleeve 110 can be made from carbon steel, 416 steel, and other metals that can be heat treated or otherwise hardened to a Rockwell “C” hardness of at least 35. Materials with a Rockwell “C” hardness of at least 35 are sufficient to alleviate the problem with the ferrule ablating inside surface 122 of sleeve 110. Additional surface treatments can also be applied after heat treating or instead of heat treating to further increase the hardness of inside surface 122. For example, a hard coating can be applied to inside surface 122 to increase the hardness by a desired amount, to at least a Rockwell “C” hardness of 35. Such coatings can include, by way of example and not limitation, titanium nitrite, and other coatings known to those of skill in the art that provide a sufficient increase in hardness to inside surface 122.

As mentioned above, sleeve 110 cooperates with base 140. With reference to FIG. 10, the base 140 includes a central bore 146 that extends from a first end 142 toward a second end 144 having an annular alignment recess 148 (FIG. 1B) formed therein. The recess 148 (FIG. 1B) is centered about bore 146. The recess 148 includes a bottom wall 150 and a sidewall 152. A post member 154 extends from bottom wall 150 and towards a center of recess 148, with bore 146 running through post member 154. This post member 154 is configured to receive second end 114 of sleeve 110 and cooperate with inside surface 122 thereof. The post member 154 can, therefore, have various configurations so long as inside surface 122 and post member 154 are complementary and can, in one configuration, interference fit one with another. It will be understood that other techniques can be used to connect sleeve 110 to post member 154.

As shown in FIGS. 1A-1D, sidewall 152 of recess 148 has a height above bottom wall 150 that is greater than that of post member 154. This is only one configuration of the present invention, and it can be understood by those skilled in the art that in some circumstances post member 154 can have a height generally the same as bottom wall 150 and even greater than bottom wall 150. In still other configurations, no post member is required.

With specific reference to FIG. 1E, base 140 also includes an annular groove 158 on an outside surface 156. Annular groove 158 is located proximal first end 142. Annular groove 158 defines a lip 160 immediately adjacent first end 142, and a tapered portion 162 on the side of groove 158 away from first end 142. With this configuration, lip 160 presents a limited quantity of material to be heated during the process of attaching base 140 to a housing 170 (FIGS. 1B and 1E). Further, with lip 160 in the presently illustrated configuration, the attachment process can occur more quickly than existing bases because a small quantity of material can be heated more quickly and hence melted more quickly to create the attachment bond.

In addition to the configuration of lip 160, tapered portion 162 also aids with the attaching process. More specifically, tapered portion 162 and a tapered portion 163 of lip 160, collectively provide clearance for equipment used during the attaching process. For instance, when a laser is used to create a weld between base 140 and housing 170, tapered portion 162 and optionally the tapered portion 163 of lip 160, collectively provide clearance for the laser beam.

Base 140 can be, by way of example and not limitation, 304 stainless steel, other stainless or non-stainless steels, or other metals known to those of skill in the art. Base 140 is welded to housing 170, which can also be 304 stainless, other stainless or non-stainless steels, or other metals known to those of skill in the art.

The specific design of base 140 shown in FIGS. 1A-1E is useful in preparing base 140 to be welded to housing 170. In one configuration, a laser beam 180, shown in FIG. 1E (not to scale) is used to create the necessary heat to weld base 140 to housing 170. Specifically, beam 180 can be directed to the edge of lip 160. In exemplary embodiments, beam 180 is a pulsed beam about 50 microns across at the point of incidence upon base 140 and housing 170. Although this is one diameter of laser beam 180, other diameters greater and lesser than 50 microns are possible.

Since base 140 is itself a heat sink, it is advantageous to keep the heat loss to a minimum. The specific design of lip 160 keeps the heat from laser beam 180 from dissipating too quickly out of the heated weld area into the larger base material during the “weld heated molten metal phase” of the penetrating root nugget development that forms the weld after cooling. Lip 160 helps achieve this by reducing the amount of material heated both by laser beam 180 to form the weld, and by allowing this reduced amount of material to heat to the melting point more rapidly than occurs in previous processes. In one exemplary embodiment, lip 160 is approximately 0.0035 inches thick at the outside edge. However, greater or lesser thicknesses, in the range from about 0.0010 to about 0.0100, are also contemplated.

As mentioned above, tapered edge 162 is designed to provide clearance for incoming laser beam 180 that actually performs the weld. In exemplary embodiments, tapered edge 162 has an angle of about 60 degrees from the horizontal. However, angles between about 30 degrees and about 80 degrees are also possible.

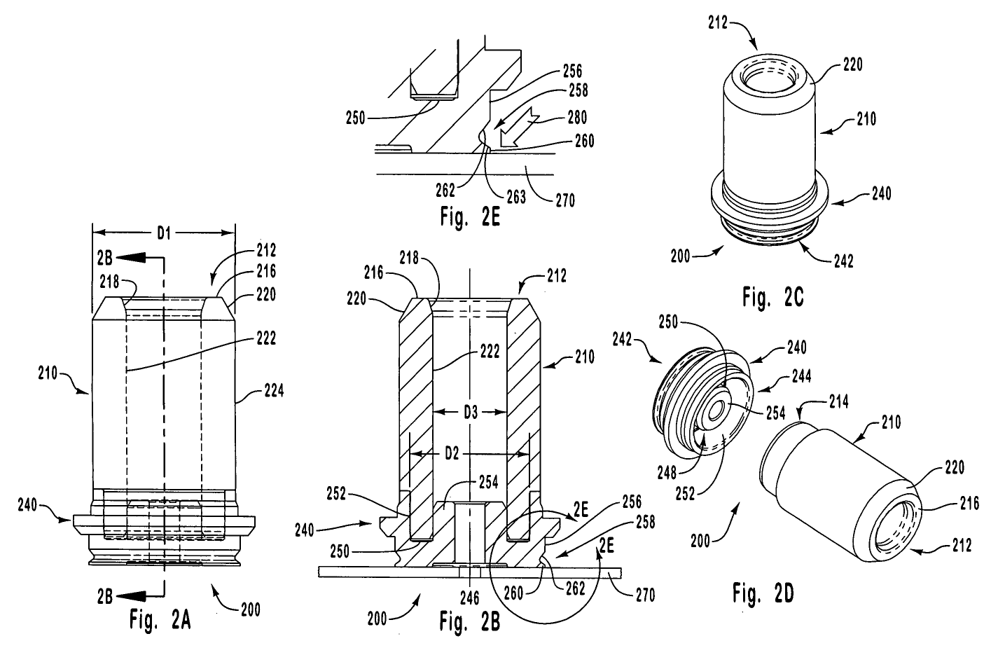

FIGS. 2A-2E illustrate different views of an alternate exemplary embodiment of a two-piece nose assembly, designated generally as reference numeral 200. In this exemplary embodiment, nose assembly 200 is designed to cooperate with a subscriber connector (SC connector, not shown). However, those skilled in the art will realize that exemplary embodiments of the present invention can be constructed to work with almost any standard connector. Such connectors can include, by way of example and not limitation, ST, STII, FC, AFC, FDDI, ESCON, and SMA, or any other connector designed to receive a ferrule. While nose assembly 200 is shown as being two pieces, exemplary embodiments of the present invention will work with nose pieces that comprise two or more pieces. The invention is therefore not limited to the two piece construction shown if FIGS. 2A-2E.

In this exemplary embodiment, nose assembly 200 includes a sleeve 210 and a base 240. This two piece construction makes machining and manufacturing the parts easier and more cost efficient. However, exemplary embodiments of the present invention can also be used with nose assemblies that have more than two parts. Such nose assemblies are also contemplated to fall within the scope of the exemplary embodiments.

In this exemplary embodiment, sleeve 210 is an annular member sized and configured to i) be interference fit into base 240, and ii) receive a ferrule (not shown) containing an optical fiber (not shown). Sleeve 210 includes a first end 212 and a second end 214. First end 212 can have a top surface 216, an inside beveled edge 218, and an outside beveled edge 220. Beveled edge 218 makes it easier to insert a ferrule (not shown) into sleeve 210, while beveled edge 220 can aid with placement of sleeve 210 relative to an optical component or other optical connector. It will be understood that second end 214 can also include one or more beveled edges. Although reference is made to the use of various beveled edges 218 and 220, one will understand that the edges of sleeve 210 can have other configurations to aid with inserting a ferrule (not shown) into sleeve 210. For instance, at least a portion of each edge 218 and 220 can have a tapered or curved profile.

In this exemplary embodiment, as illustrated in FIG. 2A, sleeve 210 has an upper outside diameter D1, a lower outside diameter D2, and an inside diameter D3. The lower outside diameter D2 is chosen to allow sleeve 210 to fit snugly into base 240. Additionally, inside diameter D2 is chosen to allow an inside surface 222 to fit snugly around a post member 254 that is internal to base 220, such that inside surface 222 can interference fit about this post member, as will be discussed in more detail hereinafter. The inside diameter D3 can be uniform for the entire length of sleeve 210.

In order to overcome the problems associated with cold welding discussed above, one exemplary embodiment provides that sleeve 210 be made from metal and that inside surface 222 be heat treated. Heat treating hardens inside surface 222 so that portions of inside surface 222 do not scrape off when a ferrule (not shown) is repeatedly inserted and removed. In an exemplary embodiment, inside surface 222 is heat treated until it has a hardness of at least 35 on the Rockwell “C” scale.

In exemplary embodiments, sleeve 210 can be made from carbon steel, 416 steel, and other metals that can be heat treated or otherwise hardened to a Rockwell “C” hardness of at least 35. Materials with a Rockwell “C” hardness of at least 35 are sufficient to alleviate the problem with the ferrule ablating inside surface 222 of sleeve 210. Additional surface treatments can also be applied after heat treating, or instead of heat treating, to further increase the hardness of inside surface 222. For example, a hard coating can be applied to inside surface 222 to increase the hardness by a desired amount, to at least a Rockwell “C” hardness of 35. Such coatings can include, by way of example and not limitation, titanium nitrite, and other coatings known to those of skill in the art that provide a sufficient increase in hardness to inside surface 222.

As mentioned above, sleeve 210 cooperates with base 240. The base 240 includes a central bore 246 that extends from a first end 242 toward a second end 244 having an annular alignment recess 248 formed therein. The recess 248 is centered about bore 246. The recess 248 includes a bottom wall 250 and a sidewall 252. A post member 254 extends from bottom wall 250 and towards a center of recess 248, with bore 246 running through post member 254. This post member 254 is configured to receive second end 214 of sleeve 210 and cooperate with inside surface 222 thereof. The post member 254 can, therefore, have various configurations so long as inside surface 222 and post member 254 are complementary and can, in one configuration, interference fit one with another. It will be understood that other techniques can be used to attach sleeve 210 to post member 254.

A shown in FIGS. 2A-2D, the sidewall 252 of recess 248 has a height above bottom wall 250 that is greater than that of post member 254. This is only one configuration of the present invention, and it can be understood by those skilled in the art that in some circumstances post member 254 can have a height generally the same as bottom wall 250 and even greater than bottom wall 250.

With specific reference to FIG. 2E, base 240 also includes an annular groove 258 on an outside surface 256. Annular groove 258 is located proximal first end 242. Annular groove 258 defines a lip 260 immediately adjacent first end 242, and a tapered portion 262 on the side of groove 258 away from first end 242. With this configuration, lip 260 presents a limited quantity of material to be heated during the process of attaching base 240 to a housing 270 (FIGS. 2B and 2E). Further, with lip 260 in the presently illustrated configuration, the attachment process can occur more quickly than existing bases because a small quantity of material can be heated more quickly and hence melted more quickly to create the attachment bond.

In addition to the configuration of lip 260, tapered portion 262 also aids with the attaching process. More specifically, tapered portion 262, and a tapered portion 263 of lip 260, collectively provide clearance for equipment used during the attaching process. For instance, when a laser is used to create a weld between base 240 and housing 270, tapered portion 262 and optionally tapered portion 263 of lip 160, collectively provide clearance for the laser beam.

Base 240 can be, by way of example and not limitation, 304 stainless steel, other stainless or non-stainless steels, or other metals known to those of skill in the art. Base 240 is welded to a housing 270 (FIGS. 2B and 2E), that can also be 304 stainless, other stainless or non-stainless steels, or other metals known to those of skill in the art.

The specific design of base 240 shown in FIGS. 2A-2E assists in preparing base 240 to be welded to housing 270. In one configuration, a laser beam 280, shown in FIG. 2E (not to scale) is used to create the necessary heat to weld base 240 to housing 270. Specifically, beam 280 can be directed to the edge of lip 260. In exemplary embodiments, beam 280 is a pulsed beam about 50 microns across at the point of incidence upon base 240 and housing 270. Although this is one diameter of laser beam 280, other diameters greater and lesser than 50 microns are possible.

Since base 240 is itself a heat sink, it is advantageous to keep the heat loss to a minimum. The specific design of lip 260 keeps the heat from laser beam 280 from dissipating too quickly out of the heated weld area into the larger base material during the “weld heated molten metal phase” of the penetrating root nugget development that forms the weld after cooling. Lip 260 helps achieve this by reducing the amount of material heated both by laser beam 280 to form the weld, and by allowing this reduced amount of material to heat to the melting point more rapidly than occurs in previous processes. In one exemplary embodiment, lip 260 is approximately 0.0035 inches thick at the outside edge. However, greater or lesser thicknesses, in the range from about 0.0010 to about 0.0100, are also contemplated.

As mentioned above, tapered edge 262 is designed to provide clearance for incoming laser beam 280 that actually performs the weld. In exemplary embodiments, tapered edge 262 has an angle of about 60 degrees from the horizontal. However, angles between about 30 degrees and about 80 degrees are also possible.

The exemplary embodiments discussed above provide some distinct advantages over previous designs. First, with respect to sleeves 110, 210, the hardening process alleviates the problem of ablation of the ferrule/sleeve that results in the cold welding problem discussed above. Ferrules can be inserted and removed as often as desired without significantly increasing the difficulty of inserting and removing the ferrule.

With respect to base members 140, 240, there are several advantages over previous designs having the base contacting the housing at a perpendicular angle. First, the lip that receives the laser beam helps to reduce the heat loss to the greater mass of the whole metal body of the base. This allows fast pulse heating to the melting temperature and a slow enough cooling phase change to a solid so as to not crystallize the weld nugget grain structure. This results in a weld that is both more uniform and stronger than previous designs.

Additionally, because the area sacrificed from the prep edge on the base to form the weld puddle is more or less the same thickness laterally with respect to the weld angle of incidence, a radial shift towards the center of the part or away from it in the originally fixed laser weld beam alignment is less sensitive compared to the 90 degree cylinder edge of previous designs. In the previous designs, if the laser beam moves a little towards the base wall, the melted area becomes just the base wall surface. If the laser beam moves a little away from the base wall, the melted area becomes only the perpendicular housing face. In either case, the two pieces are not reliably joined together. The present design is much less sensitive to these minor shifts in the laser beam placement.

The present invention may be embodied in other specific forms without departing from its spirit or essential characteristics. The described embodiments are to be considered in all respects only as illustrative and not restrictive. All changes which come within the meaning and range of equivalency of the claims are to be embraced within their scope.

1. A nose assembly that receives an optical connector, the nose assembly comprising:
a first piece having a central bore and an annular alignment-recess about said central bore; and
an annular second piece designed to receive the optical connector and having an outside surface designed to interference fit with an inside surface of said annular alignment recess, and an inner surface having a hardness of at least 35 on the Rockwell “C” scale.

2. The nose assembly of claim 1, wherein said first and second pieces comprise metal.

3. The nose assembly of claim 2, wherein said first piece comprises 304 stainless steel and wherein said second piece comprises one of carbon steel and 416 stainless steel.

4. The nose assembly of claim 1, where said hardness of said inside surface of said second piece is obtained by one of heat treating and applying a coating.

5. The nose assembly of claim 4, wherein said coating is titanium nitride.

6. The nose assembly of claim 1, wherein said first piece further comprises an annular post within said annular alignment recess, said post having said central bore therethrough, said post having an outside surface that contacts said inside surface of said second piece when said second piece is inserted into said annular alignment recess.

7. The nose assembly of claim 1, wherein said first piece has an annular groove on an outside surface thereof, said annular groove defining a lip adjacent a first end of said first piece.

8. The nose assembly of claim 1, wherein said second piece has a first end and an indicator on said outside surface near said first end, such that when said first end is inserted into said annular alignment recess, said indicator is not visible.

9. The nose assembly of claim 8, wherein said indicator is a notch in said outside surface of said second piece.

10. The nose assembly of claim 1, wherein said optical connector is any one of a SC, LC, ST, STII, FC, AFC, FDDI, ESCON, and SMA connector.

11. A system for connecting an optical connector containing an optical fiber to an optical device, the system comprising:
a housing for the optical device;
a first piece having a central bore aligned with a center of the optical fiber and an annular alignment recess about said central bore, said first piece being attached to said housing; and
an annular second piece designed to receive the optical connector and having an outside surface designed to interference fit with an inside surface of said annular alignment recess, and an inside surface having a hardness of at least 35 on the Rockwell “C” scale.

12. The system of claim 11, wherein said housing, said first piece and said second piece comprise metal.

13. The nose assembly of claim 12, wherein said first piece has an annular groove on an outside surface thereof, said annular groove defining a lip adjacent a first end of said first piece.

14. The system of claim 13, wherein said lip is attached to said housing using a welding process.

15. The system of claim 14, wherein said welding process is done with a pulsed laser.

16. The system of claim 15, wherein said annular groove has an edge tapered in a direction away from said first end.

17. The system of claim 16, wherein said tapered edge is tapered from about 30 degrees to about 80 degrees from the vertical.

18. The system of claim 16, wherein said lip has a thickness of from about 0.001 inches to about 0.01 inches and wherein said tapered edge and said lip reduce the amount of heat lost into said first piece during said welding process.

19. The system of claim 18, wherein a laser beam from said laser is from about 30 micrometers to about 80 micrometers in width.

20. The system of claim 11, wherein the optical connector is any one of a SC, LC, ST, STII, FC, AFC, FDDI, ESCON, and SMA connector.
